(19) United States
(12) Patent Application Publication
(10) Pub. No.: US 2010/0008644 A1
(43) Pub. Date: Jan. 14, 2010

(54) APPARATUS AND METHOD FOR CORRECTING RESERVATION TIME

(75) Inventor: Jeong Sim Kim, Gyeongju-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/301,436

(22) PCT Filed: May 22, 2007
(86) PCT No.: PCT/KR2007/002474

§ 371 Date: Sep. 11, 2009

(30) Foreign Application Priority Data
May 24, 2006 (KR) 10-2006-0046533

(51) Int. Cl. H04N 5/91

(52) U.S. Cl. 386/83; 386/E05.001

(57) ABSTRACT

An apparatus for correcting a reserved recording time and method thereof are disclosed. The present invention includes receiving a digital broadcast program on a selected channel, setting the reserved recording time of the digital broadcast program, deciding whether a broadcast time of the digital broadcast program is changed in a manner of confirming an EPG, and resetting the reserved recording time to be suitable for the changed broadcast time if the broadcast time is changed. Thus, even if a broadcast schedule of a program is changed under the circumstances of a transmitting side, a reserved recording time is corrected to be suitable for the changed EPG. So, there occurs no difference between a reserved recording time of a set program and a changed broadcast time of the set ro ram whereb a whole ro ram can be full recorded.

### TECHNICAL FIELD

The present invention relates to a digital broadcast receiver, and more particularly, to an apparatus for correcting a reserved recording time and method thereof.

### BACKGROUND ART

Generally, one of digital broadcasting features is to provide an electronic program guide (hereinafter abbreviated EPG). And, the EPG means ‘TV program table’.

A transport stream (TS) according to the advanced television system committee (ATSC) digital broadcasting standard normally includes an audio signal (AC3 audio), a video signal (MPEG-2 video), a control signal (MPEG-2 control), and PSIP (program and system information protocol) data.

The PSIP is the standard to describe program/data transmitted by a digital broadcast receiver and various kinds of information required for broadcast reception. And, the PSIP is a table set that is devised operative within every kind of transport stream for a digital broadcast receiver.

In the PSIP table, an event information table (EIT) enabling the electronic program guide (EPG) to be provided, a system time table (STT) indicating information for a current time, and the like are included.

So, the digital broadcast receiver is provided with the EPG via the EIT included in the PSIP table and then recognizes a broadcast schedule of a program via the EPG in advance.

A user is able to execute a reserved recording function in a manner of setting a reservation of a program broadcasted at a specific time using the EPG. So, if a reserved time comes, the corresponding program is automatically recorded.

### DISCLOSURE OF THE INVENTION

### Technical Problem

However, in the related art, if a program broadcast schedule is changed for some reasons by a transmitting side, there occurs a difference between a reserved recording time set by a user and a changed broadcast time. So, the corresponding program is not recorded entirely or recorded in part.

### Technical Solution

Accordingly, the present invention is directed to an apparatus for correcting a reserved recording time and method thereof that substantially obviate one or more of the problems due to limitations and disadvantages of the related art.

An object of the present invention is to provide an apparatus for correcting a reserved recording time and method thereof, by which the reserved recoding time in a digital broadcast receiver is corrected according to updated EPG information.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, an apparatus for correcting a reserved recording time according to the present invention includes a reserved recording time setting unit setting the reserved recording time of a broadcast program, an EPG change deciding unit deciding whether a broadcast time of the broadcast program is changed in a manner of confirming an EPG, and a reserved recording time correcting unit resetting the reserved recording time to be suitable for the changed broadcast time if the broadcast time is changed.

Preferably, the EPG change deciding unit decides whether the broadcast time of the program is changed in a manner of reading an updated EPG and comparing the broadcast time of the recording-reserved broadcast program to a current broadcast time.

Preferably, the EPG change deciding unit decides a changed status of the EPG by referring to specific event information of an event information table (EIT) included in PSIP.

More preferably, the event information includes at least one data selected from the group consisting of an intrinsic event ID, a start time, a length, a title, and a description.

Preferably, the EPG change deciding unit decides whether the broadcast time is changed in a manner of reading the EPG periodically with a preset time interval.

Preferably, after the EPG change deciding unit has decided whether the broadcast time of the broadcast program had been changed, if a corresponding time error is equal to or greater than a preset margin, the reserved recording time correcting unit corrects the reserved recording time.

Preferably, the reserved recording time correcting unit corrects the reserved recording time by a background work attributed to a multiprocessing function in the course of viewing a current broadcast program.

To further achieve these and other advantages and in accordance with the purpose of the present invention, an apparatus for correcting a reserved recording time includes a DTV tuner unit receiving a transport stream type digital broadcast program on a selected channel, a demodulator unit demodulating a transport stream received via the DTV tuner unit, a transport demux demultiplexing the demodulated transport stream into a video bit stream, an audio bit stream, and a PSIP data, a decoder unit outputting a video signal and an audio signal by decoding signals demultiplexed by the transport demux, respectively, a reserved recording time setting unit setting the reserved recording time of the digital broadcast program, an EPG change deciding unit deciding whether a broadcast time of the digital broadcast program is changed in a manner of confirming an EPG, and a reserved recording time correcting unit resetting the reserved recording time to be suitable for the changed broadcast time if the broadcast time is changed.

To further achieve these and other advantages and in accordance with the purpose of the present invention, a method of correcting a reserved recording time includes a reserved recording time setting step of setting the reserved recording time of a broadcast program, an EPG change deciding step of deciding whether a broadcast time of the broadcast program is changed in a manner of confirming an EPG, and a reserved recording time correcting step of resetting the reserved recording time to be suitable for the changed broadcast time if the broadcast time is changed.

To further achieve these and other advantages and in accordance with the purpose of the present invention, a method of correcting a reserved recording time includes a receiving step of receiving a transport stream type digital broadcast program on a selected channel, a demodulating step of demodulating a transport stream received via the receiving step, a demultiplexing step of demultiplexing the demodulated transport stream into a video bit stream, an audio bit stream, and a PSIP data, a decoding step of outputting a video signal and an audio signal by decoding signals demultiplexed by the demultiplexing step, respectively, a reserved recording time setting step of setting the reserved recording time of the digital broadcast program, an EPG change deciding step of deciding whether a broadcast time of the digital broadcast program is changed in a manner of confirming an EPG, and a reserved recording time correcting step of resetting the reserved recording time to be suitable for the changed broadcast time if the broadcast time is changed.

It is to be understood that both the foregoing general description and the following detailed description are exemplary and explanatory and are intended to provide further explanation of the invention as claimed.

### ADVANTAGEOUS EFFECTS

Accordingly, the present invention readjusts a preset reserved recording time to be suitable for EPG change information in accordance with an EPG change due to a broadcast time or program change, thereby enabling a user-specific broadcast to be completely recorded at a precise time without a missing part of the broadcast or unnecessary information storage.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of an apparatus for correcting a reserved recording time in a digital broadcast receiver according to one embodiment of the present invention;

FIG. 2 is a detailed block diagram of a control unit of the apparatus shown in FIG. 1;

FIG. 3 is a flowchart of a method of correcting a reserved recording time in a digital broadcast receiver according to one embodiment of the present invention; and

FIG. 4 is a detailed flowchart of EPG change decision and reserved recording correction of the method shown in FIG. 3.

### BEST MODE

### Mode for Invention

Reference will now be made in detail to the preferred embodiments of the present invention, examples of which are illustrated in the accompanying drawings.

First of all, a digital broadcast receiver of the present invention includes such a device as a television receiver displaying an image by receiving radio waves from a broadcasting station, a set-top box (STB), a personal video recorder (PVR) recording and reproducing video data by loading a hard disc drive (HDD) in a television body, and the like.

An apparatus for correcting a reserved recording time in a digital broadcast receiver and method thereof are explained in detail with reference to the attached drawings as follows.

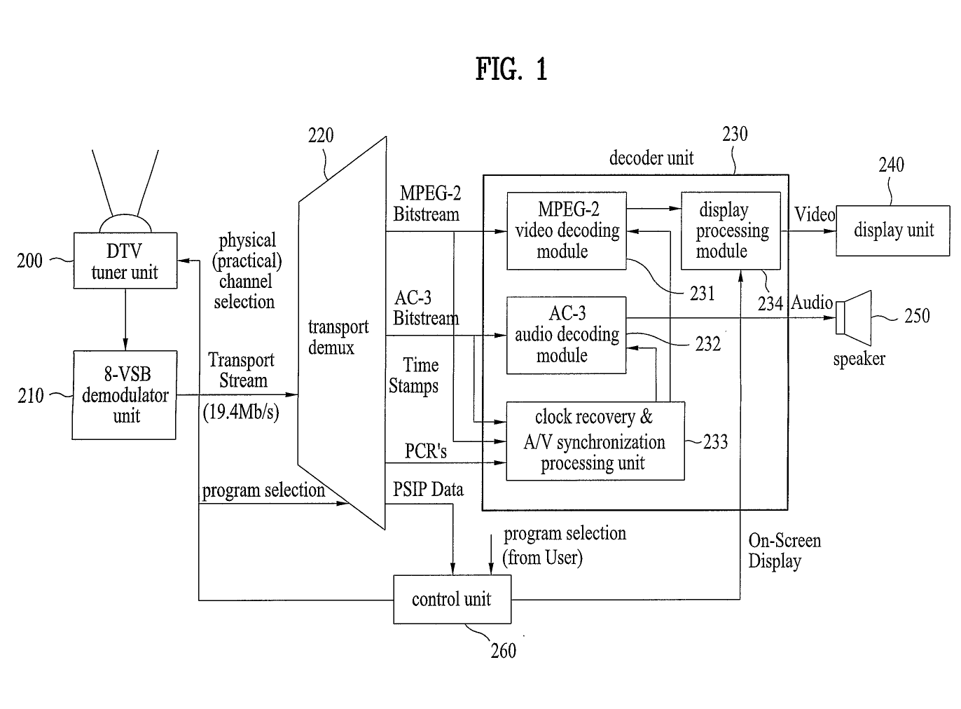

FIG. 1 is a block diagram of an apparatus for correcting a reserved recording time in a digital broadcast receiver according to one embodiment of the present invention.

Referring to FIG. 1, an apparatus for correcting a reserved recording time in a digital broadcast receiver according to one embodiment of the present invention includes a DTV tuner unit 200, a demodulator unit 210, a transport demux 220, a decoder unit 230, a video decoding module 231, an audio decoding module 232, a clock recovery & A/V synchronization processing unit 233, a display processing module 234, a display unit 240, a speaker 250, a control unit 260, and a storage unit 270.

The DTV tuner unit 200 receives a transport stream type digital broadcast signal on a selected channel.

The demodulator unit 210 demodulates the transport stream received by the DTV tuner unit 200.

The transport demux 220 demultiplexes the demodulated transport stream into a video bit stream, an audio bit stream, and PSIP data.

The decoder unit 230 decodes the respective signals demultiplexed by the transport demux 220 and then outputs a video signal and an audio signal, respectively.

For this, the decoder unit 230 includes the video decoding module 231, the audio decoding module 232, the clock recovery & A/V synchronization processing unit 233, and the display processing module 234.

In particular, the video decoding module 231 decodes the video bit stream (MPEG-2 Bitstream) into a video signal. The audio decoding module 232 decodes the audio bit stream (AC-3 Bitstream) into an audio signal. The clock recovery & A/V synchronization processing unit 233 receives time stamp signals (Time Stamps) from the video and audio bit streams and then processes the received signals into clock recovery & A/V synchronization signals of the video and audio decoding modules 232 and 232, respectively. And, the display processing module 234 processes the video signal decoded by the video decoding module 231 into a displayable video output format.

Meanwhile, the display unit 240 displays the video signal on a screen and the speaker 250 outputs the audio signal to an indoor/outdoor space.

The display 240 can include one of various display devices such as a CRT, a PDP, an LCD, an OLED, a projection, and the like as a screen that configures real images thereon.

The control unit 260 confirms a presence or non-presence of a change of an EPG included in the PSIP data, adjusts a preset reserved recording time to fit the changed EPG, and makes a video signal, which is received to correspond to the adjusted time, stored in the storage unit 270.

The control unit 260 outputs a channel and program selection signal to the DTV tuner unit 200 and the demodulator unit 210 according to a user's program selection and the PSIP data outputted from the transport demux 220.

The control unit 260 can include such a normal control means for having functions of decision and operation as a microprocessor, a microcomputer, a CPU (central processing unit), an MPU (microprocessor unit), and the like.

For instance, the control unit 260 can decide a changed EPG status with reference to event information of an event information table (EIT) included in the PSIP data.

In this case, the event information includes at least one data selected from the group consisting of intrinsic event ID, start time, length, title, and description.

The storage unit 270 stores the video signal received via the DTV tuner unit 200 at the adjusted reserved recording time under the control of the control unit 260.

And, the storage unit 270 can include one of various memory devices such a volatile memory (RAM), a non-volatile memory (ROM), a magnetic disc, an optical disc, and the like.

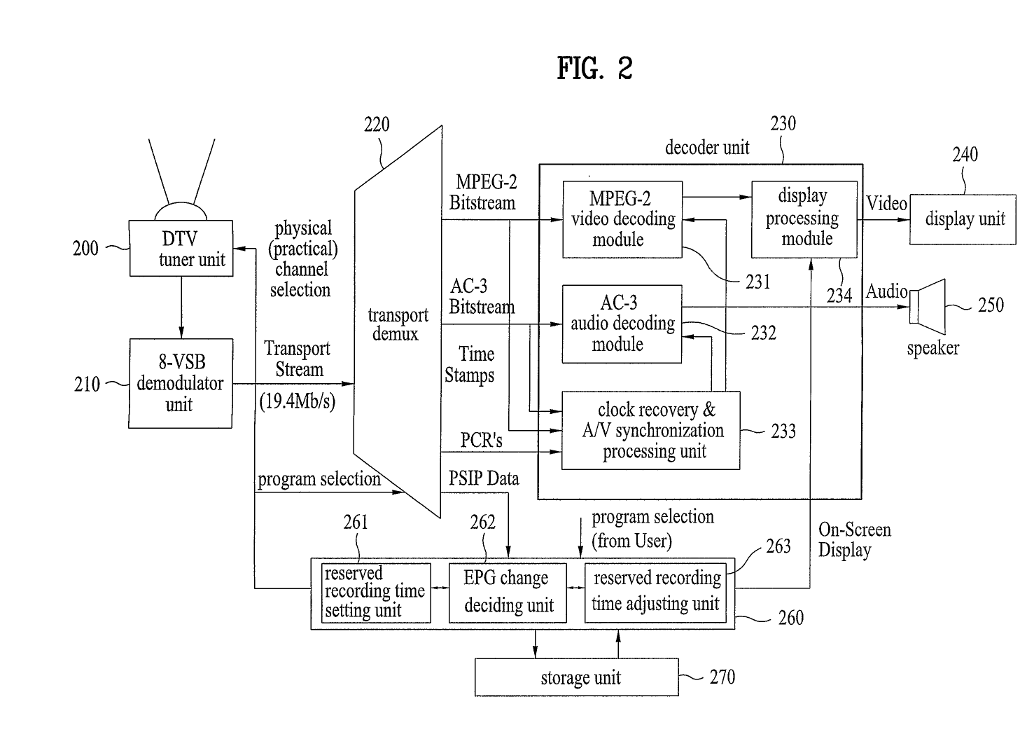

FIG. 2 is a detailed block diagram of a control unit of the reserved recording time correcting apparatus shown in FIG. 1.

Referring to FIG. 2, as mentioned in the foregoing description, the present invention includes a DTV tuner unit 200, a demodulator unit 210, a transport demux 220, a decoder unit 230, a video decoding module 231, an audio decoding module 232, a clock recovery & A/V synchronization processing unit 233, a display processing module 234, a display unit 240, a speaker 250, a control unit 260, and a storage unit 270.

Yet, if an EPG included in the PSIP data is changed, the control unit 260 adjusts a preset reserved recording time to be suitable for a changed status of the EPG and then makes a video signal, which is received in correspondence to an adjusted program broadcast time, stored in the storage unit 270.

For this, the control unit 260 includes a reserved recording time setting unit 261, an EPG change deciding unit 262, and a reserved recording time adjusting unit 263.

The reserved recording time setting unit 261 decides a reserved recording time previously set by a user.

The EPG change deciding unit 262 decides an changed EPG status with reference to specific event information of an event information table (EIT) included in PSIP.

For instance, the EPG change deciding unit 262 periodically reads the updated EPG with a preset time interval to decide a presence or non-presence of the broadcast time change.

In case of deciding a changed status of the EPG from the EPG change deciding unit 262, the reserved recording time adjusting unit 263 readjusts the reserved recording time previously set by the reserved recording time setting unit 261 into a time changed suitable for the updated EPG.

For instance, on the condition that the change of the broadcast time of the program is decided, if a corresponding time error is equal to or greater than a preset margin, the reserved recording time adjusting unit 263 is able to correct or adjust the reserved recording time.

For another instance, the reserved recording time adjusting unit 263 is able to perform the reserved recording time adjusting work using a background work by a multiprocessing function while a current broadcast program is viewed.

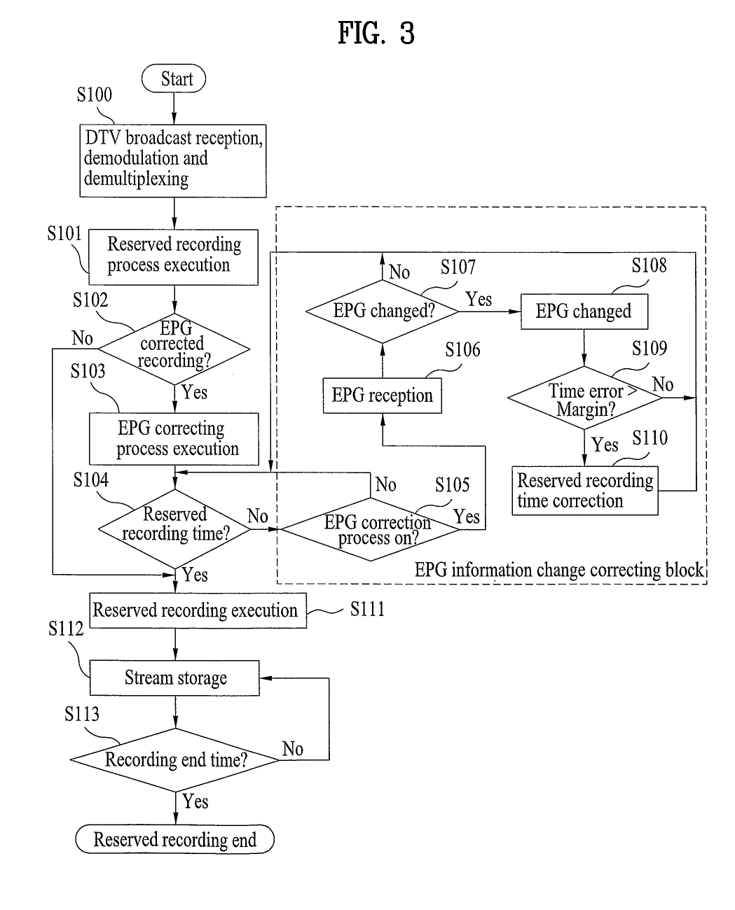

FIG. 3 is a flowchart of a method of correcting a reserved recording time in a digital broadcast receiver according to one embodiment of the present invention.

Referring to FIG. 3, in the present invention, a transport stream type digital broadcast program is received on a selected channel and the received transport stream is demodulated. The demodulated transport stream is demultiplexed into a video bit stream, an audio bit stream, and PSIP data. The demultiplexed signals are decoded by a transport demux and then outputted as video and audio signals (S100).

Subsequently, a reserved recording time of the broadcast program is set. After an EPG has been confirmed, it is decided whether a broadcast time of the program is changed. If the broadcast time is changed, the reserved recording time is reset to correspond to the changed broadcast time (S101 to S111).

Thereafter, a video signal received to correspond to the reset reserved recording time is stored (S112, S113).

In this case, in case of the EPG change decision, the presence or non-presence of the broadcast time change of the program is decided by reading the updated EPG and then comparing the broadcast time of the recording-reserved program to a current broadcast time (S106, S107).

In case of the reserved recording time correction, on the condition that the broadcast time change of the program is decided in the deciding step, if a corresponding time error is equal to or greater than a preset margin, the reserved recording time is corrected (S108 to S110).

The above-configured method according to one embodiment of the present invention is explained in detail with reference to FIGS. 1 to 3 as follows.

First of all, the DTV tuner unit 200 receives a transport stream type digital broadcast signal on a selected channel. The demodulator unit 210 demodulates the transport stream received via the DTV tuner unit 200. The transport demux 220 then demultiplexes the demodulated transport stream into a video stream, an audio stream, and PSIP data (S100).

The respective signals demultiplexed by the transport demux 220 are decoded by the decoder unit 230 into video and audio signals.

In particular, the video decoding module 231 of the decoder unit 230 decodes the video bit stream (MPEG-2 Bitstream) into a video signal. The audio decoding module 232 decodes the audio bit stream (AC-3 Bitstream) into an audio signal. The clock recovery & A/V synchronization processing unit 233 receives time stamp signals (Time Stamps) from the video and audio bit streams and then processes the received signals into clock recovery & A/V synchronization signals of the video and audio decoding modules 232 and 232, respectively. And, the display processing module 234 processes the video signal decoded by the video decoding module 231 into a displayable video output format.

Moreover, the display unit 240 displays the video signal on a screen and the speaker 250 outputs the audio signal to an indoor/outdoor space.

While a series of the above displayed procedures are carried out, if a reserved recording process according to the present invention is executed (S101), a user selects a corrected recording according to an EPG change (S102). Namely, according to a user's selection, it is able to selectively execute a corrected recording in association with the EPG change or a normal reserved recording having nothing to do with the EPG change.

In case that a user selects the normal reserved recording, a reserved recording is executed at a preset time regardless of the EPG change to store a corresponding vide stream until a recording time ends (S111˜S1113).

In case that a user selects the EPG corrected recording, an EPG correcting process is initiated (S102, S103). In this case, the EPG correcting process is turned on and executed only if the preset reserved recording time fails to come (S104, S105).

First of all, the reserved recording time setting unit 261 of the control unit 260 has set a reserved recording time inputted in advance by a user prior to the EPG correcting process execution.

Subsequently, the EPG change deciding unit 262 receives an updated EPG and then decides a broadcast time changed status of a reserved recording program according to an EPG change (S106, S107).

In this case, the EPG change decision is carried out in a manner of reading the updated EPG and then deciding a presence or non-presence of the broadcast time change of the program by comparing a broadcast time of the reserved recording program and a current broadcast time.

So, in case that the EPG change status is decided by the EPG change deciding unit 262, an EPG change margin is decided. So, a reserved recording time correcting work is carried out only if a time error is equal to or greater than a prescribed margin value (S108, S109).

If the time error lies within the margin value, the EPG change is ignored and the previously set reserved recording time is maintained intact. In this case, the margin value is determined by considering an advertisement time. Since an advertisement time is not represented by the EPG in general, the error is corrected by giving a prescribed margin value to the reserved recording time.

The reserved recording time adjusting unit 263 adjusts the reserved recording time previously set by the reserved recording time deciding unit 261 to be suitable for the updated EPG only if the EPG change status is decided by the EPG change deciding unit 262 (S110).

Thus, even if a broadcast schedule of a program is changed under the circumstances of a transmitting side, a reserved recording time is corrected to be suitable for the changed EPG. So, there occurs no difference between a reserved recording time of a set program and a changed broadcast time of the set program, whereby a whole program can be fully recorded.

Meanwhile, the PSIP data of the present invention includes SST (System Time Table), MGT (Master Guide Table), VCT (Virtual Channel Table), RRT (Rating Region Table), EIT (Event Information Table), and ETT (Extended Text Table).

And, the respective tables provide the additional information shown in Table 1.

TABLE 1

| | Contents of Provided |
|---|---|
| Table Name | Additional Information |
| STT (System Time Table) | Date and time |
| MGT (Master Guide Table) | All tables except version, |
| | size, PID, and STT |
| VCT (Virtual Channel Table) | Virtual channel feature of |
| | transport stream |
| RRT (Rating Region Table) | Rating information of multi- |
| | region [symbol] |
| EIT (Event Information Table) | Event information of virtual |
| | channel |
| ETT (Extended Text Table) | Details of virtual channel |
| | and event |

So, the control unit 260 of the present invention decides the EPG change status by referring to event information of the event information table (EIT) specifically. In this case, the event information includes at least one data of intrinsic event ID, start time, length, title, and description.

Optionally, the EPG change status can be decided by comparing at least one of a plurality of the event informations.

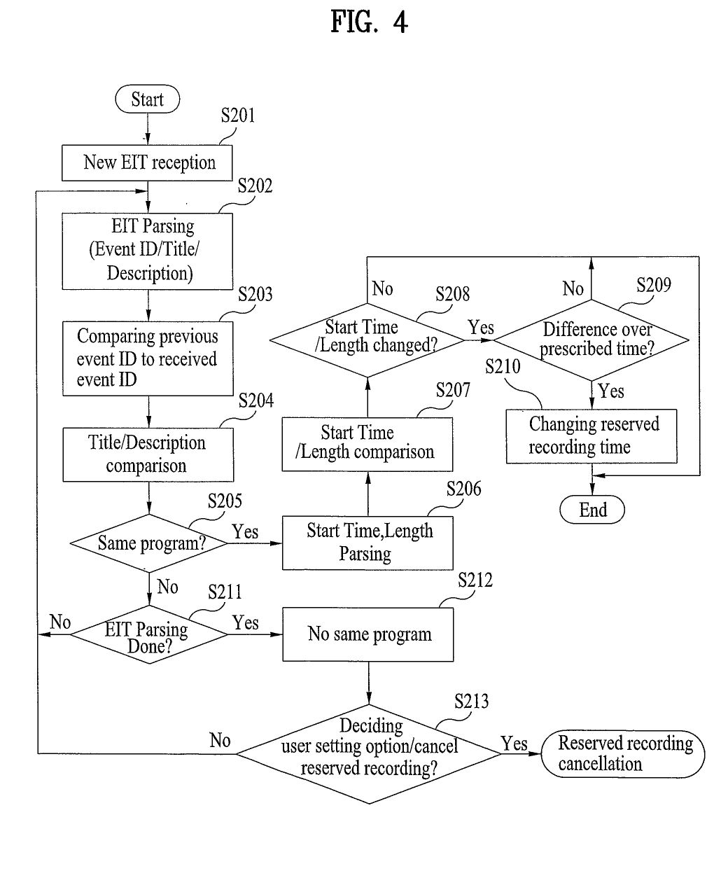

FIG. 4 is a detailed flowchart of EPG change decision and reserved recording correction of the method shown in FIG. 3.

In case of an EPG change decision, the EPG change status is decided by referring to specific event information of the event information table (EIT) included in PSIP. In this case, the event information includes at least one data of intrinsic event ID, start time, length, title, and description.

In case of the EPG change decision, a presence or non-presence of the broadcast time change is decided in a manner of periodically reading the EPG with a preset time interval.

In case of the reserved recording time correction, the reserved recording time correcting work is carried out by a background work according to a multiprocessing function in the course of viewing a current broadcast program.

The above-configured method according to another embodiment of the present invention is explained in detail with reference to FIG. 1, FIG. 2, and FIG. 4 as follows.

Referring to FIG. 4, if a new EIT is received (S201), contents including an event ID, a title, a description and the like of the received EIT are parsed with reference to the PSIP data and a previous event ID and a received event ID are compared to each other (S202, S203).

And, by comparing titles and descriptions, it is decided whether there is a program equal to a reserved program (S204, S205).

If it is decided that there is the same program, a start time and length of the corresponding program are parsed (S206). They are then compared to decide whether there is a changed item (S207, S208).

If there is the changed item, it is decided whether there is a difference over a prescribed time (S209). In this case, the difference over the prescribed time can be understood as the aforesaid margin value that considers the advertisement time.

If there is the difference over the prescribed time, a preset reserved recording time is changed into a broadcast time changed according to an EPG update (S205˜S210).

Through the above steps, the control unit 260 controls the storage unit 270 to store a video stream received via the DTV tuner unit 200 at the corrected reserved recording time.

Meanwhile, if the step S205 decides that there is not the program equal to the reserved program, the EIT stops being parsed, a user setting option according to the non-existence of the same program is decided, and the reserved recording is cancelled (S211˜S213).

### INDUSTRIAL APPLICABILITY

Accordingly, the present invention readjusts a preset reserved recording time to be suitable for EPG change information in accordance with an EPG change due to a broadcast time or program change, thereby enabling a user-specific broadcast to be completely recorded at a precise time without a missing part of the broadcast or unnecessary information storage.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. An apparatus for correcting a reserved recording time, comprising:
a reserved recording time setting unit setting the reserved recording time of a broadcast program;
an EPG change deciding unit deciding whether a broadcast time of the broadcast program is changed in a manner of confirming an EPG; and
a reserved recording time correcting unit resetting the reserved recording time to be suitable for the changed broadcast time if the broadcast time is changed.

2. The apparatus of claim 1, wherein the EPG change deciding unit decides whether the broadcast time of the program is changed in a manner of reading an updated EPG and comparing the broadcast time of the recording-reserved broadcast program to a current broadcast time.

3. The apparatus of claim 1, wherein the EPG change deciding unit decides a changed status of the EPG by referring to specific event information of an event information table (EIT) included in PSIP.

4. The apparatus of claim 3, wherein the event information comprises at least one data selected from the group consisting of an intrinsic event ID, a start time, a length, a title, and a description.

5. The apparatus of claim 1, wherein the EPG change deciding unit decides whether the broadcast time is changed in a manner of reading the EPG periodically with a preset time interval.

6. The apparatus of claim 1, wherein after the EPG change deciding unit has decided whether the broadcast time of the broadcast program had been changed, if a corresponding time error is equal to or greater than a preset margin, the reserved recording time correcting unit corrects the reserved recording time.

7. The apparatus of claim 1, wherein the reserved recording time correcting unit corrects the reserved recording time by a background work attributed to a multiprocessing function in the course of viewing a current broadcast program.

8. An apparatus for correcting a reserved recording time, comprising:
a DTV tuner unit receiving a transport stream type digital broadcast program on a selected channel;
a demodulator unit demodulating a transport stream received via the DTV tuner unit;
a transport demux demultiplexing the demodulated transport stream into a video bit stream, an audio bit stream, and a PSIP data;
a decoder unit outputting a video signal and an audio signal by decoding signals demultiplexed by the transport demux, respectively;
a reserved recording time setting unit setting the reserved recording time of the digital broadcast program;
an EPG change deciding unit deciding whether a broadcast time of the digital broadcast program is changed in a manner of confirming an EPG; and
a reserved recording time correcting unit resetting the reserved recording time to be suitable for the changed broadcast time if the broadcast time is changed.

9. The apparatus of claim 8, further comprising a storage unit storing the video signal received via the DTV tuner unit to be suitable for the reserved recording time reset by the reserved recording time correcting unit.

10. A method of correcting a reserved recording time, comprising:
a reserved recording time setting step of setting the reserved recording time of a broadcast program;
an EPG change deciding step of deciding whether a broadcast time of the broadcast program is changed in a manner of confirming an EPG; and
a reserved recording time correcting step of resetting the reserved recording time to be suitable for the changed broadcast time if the broadcast time is changed.

11. The method of claim 10, wherein the EPG change deciding step decides whether the broadcast time of the program is changed in a manner of reading an updated EPG and comparing the broadcast time of the recording-reserved broadcast program to a current broadcast time.

12. The method of claim 10, wherein the EPG change deciding step decides a changed status of the EPG by referring to specific event information of an event information table (EIT) included in PSIP.

13. The method of claim 12, wherein the event information comprises at least one data selected from the group consisting of an intrinsic event ID, a start time, a length, a title, and a description.

14. The method of claim 1, wherein the EPG change deciding step decides whether the broadcast time is changed in a manner of reading the EPG periodically with a preset time interval.

15. The method of claim 10, wherein after the EPG change deciding step has decided whether the broadcast time of the broadcast program had been changed, if a corresponding time error is equal to or greater than a preset margin, the reserved recording time correcting step corrects the reserved recording time.

16. The method of claim 10, wherein the reserved recording time correcting step corrects the reserved recording time by a background work attributed to a multiprocessing function in the course of viewing a current broadcast program.

17. A method of correcting a reserved recording time, comprising:
a receiving step of receiving a transport stream type digital broadcast program on a selected channel;
a demodulating step of demodulating a transport stream received via the receiving step;
a demultiplexing step of demultiplexing the demodulated transport stream into a video bit stream, an audio bit stream, and a PSIP data;
a decoding step of outputting a video signal and an audio signal by decoding signals demultiplexed by the demultiplexing step, respectively;
a reserved recording time setting step of setting the reserved recording time of the digital broadcast program;
an EPG change deciding step of deciding whether a broadcast time of the digital broadcast program is changed in a manner of confirming an EPG; and
a reserved recording time correcting step of resetting the reserved recording time to be suitable for the changed broadcast time if the broadcast time is changed.

18. The method of claim 17, further comprising a storing step of storing the video signal received via the receiving step to be suitable for the reserved recording time reset by the reserved recording time correcting step.
